(19) United States
(12) Patent Application Publication
(10) Pub. No.: US 2026/0128285 A1
(43) Pub. Date: May 7, 2026

(54) CATHODE FOR LITHIUM SECONDARY BATTERY AND LITHIUM SECONDARY BATTERY INCLUDING THE SAME

(71) Applicant: SK ON CO., LTD., Seoul (KR)

(72) Inventors: Ji Hee BAE, Daejeon (KR); Jae Ram KIM, Daejeon (KR); Yeon Hwa SONG, Daejeon (KR); Jeong Seok YEON, Daejeon (KR)

(21) Appl. No.: 19/340,782

(22) Filed: Sep. 25, 2025

(30) Foreign Application Priority Data
Nov. 1, 2024 (KR) 10-2024-0153380

(51) Int. Cl. H01M 4/36; H01M 4/02; H01M 4/525; H01M 4/58; H01M 10/052

(52) U.S. Cl. CPC H01M 4/366; H01M 4/525; H01M 4/5825; H01M 10/052; H01M 2004/028

(57) ABSTRACT

A cathode for a lithium secondary battery according to an embodiment of the present disclosure includes: a cathode current collector; and a cathode mixture layer on at least one surface of the cathode current collector, and the cathode mixture layer includes: a first cathode mixture layer on the cathode current collector; and a second cathode mixture layer on the first cathode mixture layer, each of the first cathode mixture layer and the second cathode mixture layer independently includes a lithium metal phosphate as an active material, at least one of the first cathode mixture layer and the second cathode mixture layer includes a lithium transition metal oxide as an active material, and a weight of the lithium metal phosphate included in the first cathode mixture layer is greater than or equal to a weight of the lithium metal phosphate included in the second cathode mixture layer.

### CROSS-REFERENCE TO RELATED APPLICATION(S)

This patent document claims the priority and benefits of Korean Patent Application No. 10-2024-0153380 filed on Nov. 1, 2024, the disclosure of which is incorporated herein by reference in its entirety.

### TECHNICAL FIELD

The disclosure and implementations disclosed in this patent document generally relate to a cathode for a lithium secondary battery and a lithium secondary battery including the same.

### BACKGROUND

Recently, extensive research has been conducted on electric vehicles (EV) that may replace fossil fuel-powered vehicles, such as gasoline and diesel vehicles, which are one of the main causes of air pollution, and a lithium secondary battery, with high discharge voltage and power stability, may be primarily used as a power source for such EVs.

To enhance the performance of a lithium secondary battery, the development of technologies that may improve the energy density and safety of such a lithium secondary battery is essential.

### SUMMARY

According to an aspect of the present disclosure, a cathode for a lithium secondary battery having improved safety may be provided.

According to another aspect of the present disclosure, the energy density of a cathode for a lithium secondary battery may be improved.

According to another aspect of the present disclosure, the lifespan performance of a cathode for a lithium secondary battery may be improved.

A cathode for a lithium secondary battery according to an embodiment may include: a cathode current collector; and a cathode mixture layer on at least one surface of the cathode current collector, and the cathode mixture layer may include: a first cathode mixture layer on the cathode current collector; and a second cathode mixture layer on the first cathode mixture layer, each of the first cathode mixture layer and the second cathode mixture layer may independently include a lithium metal phosphate as an active material, at least one of the first cathode mixture layer and the second cathode mixture layer may include a lithium transition metal oxide as an active material, and a weight of the lithium metal phosphate included in the first cathode mixture layer may be greater than or equal to a weight of the lithium metal phosphate included in the second cathode mixture layer.

In some embodiments, when the first cathode mixture layer includes a lithium transition metal oxide, a weight of the lithium metal phosphate included in the first cathode mixture layer may be greater than or equal to a weight of the lithium transition metal oxide included in the first cathode mixture layer.

In some embodiments, a weight ratio of the lithium metal phosphate and the lithium transition metal oxide included in the first cathode mixture layer may be 70:30 to 99:1.

In some embodiments, when the second cathode mixture layer includes a lithium transition metal oxide, a weight ratio of the lithium metal phosphate and the lithium transition metal oxide included in the second cathode mixture layer is 30:70 to 70:30.

In some embodiments, a total weight of the lithium metal phosphate included in the cathode mixture layer may be greater than or equal to a total weight of the lithium transition metal oxide included in the cathode mixture layer.

In some embodiments, a weight ratio of the lithium metal phosphate and the lithium transition metal oxide included in the cathode mixture layer may be 60:40 to 80:20.

In some embodiments, a loading weight (LW) ratio of the first cathode mixture layer and the second cathode mixture layer is 30:70 to 70:30.

In some embodiments, the lithium metal phosphate may be a lithium manganese iron phosphate (LMFP)-based active material represented by a chemical formula, LiMnₓFe₁₋ₓPO₄ (0<x<1).

In some embodiments, the lithium transition metal oxide may have a single particle form.

A lithium secondary battery according to an embodiment may include the cathode for a lithium secondary battery in the above-described embodiments.

According to an embodiment of the present disclosure, the safety of a cathode for a lithium secondary battery may be improved.

According to another embodiment of the present disclosure, a cathode for a lithium secondary battery having high-energy density may be provided.

According to another embodiment of the present disclosure, a cathode for a lithium secondary battery having excellent lifespan performance may be provided.

### BRIEF DESCRIPTION OF DRAWINGS

Certain aspects, features, and advantages of the present disclosure are illustrated by the following detailed description with reference to the accompanying drawings.

FIG. 1 is a cross-sectional view conceptually illustrating a cathode for a lithium secondary battery according to an embodiment.

### DETAILED DESCRIPTION

Hereinafter, the technology disclosed in this specification and embodiments thereof will be described in detail with reference to the accompanying drawings. However, the embodiments of the technology may be modified in various other forms, and the scope thereof is not limited to the embodiments described below. Furthermore, the technology disclosed in this specification may be applied by being limited to the components of the embodiments to be described below, and may be configured by selectively combining all or some of the embodiments so that various modifications may be made.

As demands for a lithium secondary battery increase, there is a need for technology that may manufacture cathodes having excellent performance. In this regard, when NCM cells using NCM (lithium nickel-cobalt-manganese oxide) as a cathode active material, the NCM cells may have excellent energy density, but may have the disadvantages of relatively low safety and high costs. Conversely, cells to which a lithium-phosphate-based material having an olivine structure, such as a lithium iron phosphate (LFP)-based active material as a cathode active material, is applied, may have excellent safety and price competitiveness, but may have the disadvantages of relatively poor energy density and low-temperature performance.

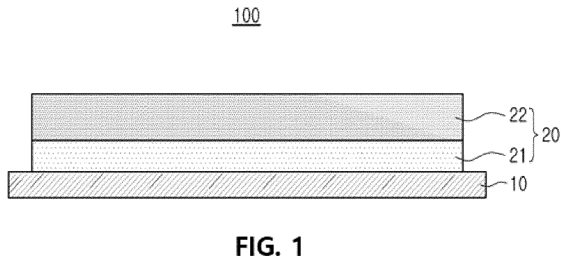

According to an embodiment of the present disclosure, the aforementioned problems may be alleviated to provide a cathode for a lithium secondary battery with superior energy density, superior safety, a superior cycle lifespan, and superior price competitiveness. Hereinafter, embodiments of the present disclosure will be described in detail with reference to FIG. 1.

FIG. 1 is a cross-sectional view conceptually illustrating a cathode for a lithium secondary battery according to an embodiment.

### Cathode for Lithium Secondary Battery

A cathode 100 for a lithium secondary battery according to an embodiment includes a cathode current collector 10; and a cathode mixture layer 20 on at least one surface of the cathode current collector, and the cathode mixture layer includes a first cathode mixture layer 21 on the cathode current collector 10; and a second cathode mixture layer 22 on the first cathode mixture layer. The first cathode mixture layer 21 and the second cathode mixture layer 22 each independently include a lithium metal phosphate as an active material, and at least one of the first cathode mixture layer 21 or the second cathode mixture layer 22 includes a lithium transition metal oxide as an active material, and a weight of the lithium metal phosphate included in the first cathode mixture layer 21 is greater than or equal to a weight of the lithium metal phosphate included in the second cathode mixture layer 22.

The lithium transition metal oxide may include an active material such as lithium nickel-cobalt-manganese oxide (NCM), which has excellent energy density, and the lithium metal phosphate may include an active material such as lithium iron phosphate (LFP), as an active material having an olivine structure having excellent structural stability.

The cathode 100 for a lithium secondary battery has a multilayer structure including both lithium transition metal oxide and lithium metal phosphate as active materials (see FIG. 1), and thus, this structure may complement the shortcomings of each active material while maximizing advantages thereof, thereby contributing to further cell performance improvement. The components of the cathode current collector 10 are not particularly limited. For example, the cathode current collector may be a plate or a foil formed of one or more of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and alloys thereof. In some embodiments, the cathode current collector may be aluminum foil (Al-foil).

A thickness of the cathode current collector 10 is not particularly limited. For example, the thickness of the cathode current collector may be 0.1 to 50 μm. In some embodiments, the thickness of the cathode current collector may be 5 μm or more or 10 μm or more, and 30 μm or less or 20 μm or less.

In some embodiments, in the cathode 100 for a lithium secondary battery, a content of lithium metal phosphate included in the first cathode mixture layer 21, which is a lower layer, may be greater than a content of the lithium metal phosphate included in the second cathode mixture layer 22, which is an upper layer. Specifically, a weight of the lithium metal phosphate included in the first cathode mixture layer 21 may be greater than a weight of the lithium metal phosphate included in the second cathode mixture layer 22.

In some embodiments, each of the first cathode mixture layer 21 and the second cathode mixture layer 22 may include a lithium transition metal oxide. When each of the first cathode mixture layer 21 and the second cathode mixture layer 22 includes only lithium metal phosphate, electrode processability (viscosity and cathode density) may be inadequate. Accordingly, when each of the first cathode mixture layer 21 and the second cathode mixture layer 22 includes both lithium metal phosphate and lithium transition metal oxide, electrode processability may be improved.

In some embodiments, the first cathode mixture layer 21, which is a lower layer adjacent to the cathode current collector 10, may include lithium transition metal oxide. According to an embodiment, the content of lithium metal phosphate in the first cathode mixture layer 21 may be greater than or equal to the content of lithium transition metal oxide. Specifically, when the first cathode mixture layer 21 includes lithium transition metal oxide, the weight of the lithium metal phosphate included in the first cathode mixture layer 21 may be greater than or equal to the weight of the lithium transition metal oxide included in the first cathode mixture layer 21.

In some embodiments, a weight ratio of the lithium metal phosphate and lithium transition metal oxide included in the first cathode mixture layer 21 may be 70:30 to 99:1. Specifically, the weight ratio of the lithium metal phosphate and lithium transition metal oxide included in the first cathode mixture layer 21 may be 85:15 to 95:5. In this case, the energy density of the cathode 100 for a lithium secondary battery may be secured while significantly improving the safety of the battery.

In some embodiments, the second cathode mixture layer 22 may include a lithium transition metal oxide. According to an embodiment, when the second cathode mixture layer 22 includes a lithium transition metal oxide, a weight ratio of the lithium metal phosphate and lithium transition metal oxide included in the second cathode mixture layer 22 may be 30:70 to 70:30. Specifically, the weight ratio of lithium metal phosphate and lithium transition metal oxide included in the second cathode mixture layer 22 may be 40:60 to 60:40, or 45:55 to 55:45. In this case, the safety of the cathode 100 for a lithium secondary battery may be ensured while significantly improving the energy density of the battery.

In some embodiments, the content of lithium metal phosphate included in the first cathode mixture layer 21 may be 40 to 100 wt %. Specifically, the content of lithium metal phosphate included in the first cathode mixture layer 21 may be 60 wt % or more, 70 wt % or more, 80 wt % or more, or 85 wt % or more, and may be 100 wt % or less.

In some embodiments, the content of the lithium transition metal oxide included in the first cathode mixture layer 21 may be 0 to 60 wt %. Specifically, the content of the lithium transition metal oxide included in the first cathode mixture layer 21 may be 0 wt % or more or 5 wt % or more, and may be 40 wt % or less, 30 wt % or less, 20 wt % or less, or 10 wt % or less.

In some embodiments, the content of the lithium metal phosphate included in the second cathode mixture layer 22 may be 40 to 100 wt %. Specifically, the content of the lithium metal phosphate included in the second cathode mixture layer 22 may be 40 wt % or more, 80 wt % or less, 70 wt % or less, 60 wt % or less, or 50 wt % or less.

In some embodiments, the content of lithium transition metal oxide included in the second cathode mixture layer 22 may range from 0 to 60 wt %. Specifically, the content of lithium transition metal oxide included in the second cathode mixture layer 22 may be 20 wt % or more, 30 wt % or more, or 40 wt % or more, and may be 50 wt % or less.

In some embodiments, when the first cathode mixture layer 21 having a relatively higher content of lithium metal phosphate is disposed in the lower layer adjacent to the cathode current collector 10, and the second cathode mixture layer 22 having a relatively higher content of lithium transition metal oxide is disposed in the upper layer, the capacity and energy density of the lithium secondary battery may be improved while simultaneously ensuring safety.

In some embodiments, in the cathode 100 for a lithium secondary battery, the content of the lithium metal phosphate may be greater than or equal to the content of lithium transition metal oxide based on the entire cathode mixture layer 20. Specifically, a total weight of the lithium metal phosphate included in the cathode mixture layer 20 may be greater than or equal to a total weight of the lithium transition metal oxide included in the cathode mixture layer 20.

In some embodiments, a weight ratio of the lithium metal phosphate and the lithium transition metal oxide included in the cathode mixture layer 20 may be 60:40 to 80:20. Specifically, the weight ratio of the lithium metal phosphate and the lithium transition metal oxide included in the cathode mixture layer 20 may be 65:35 to 75:25. In this case, the energy density of the cathode 100 for a lithium secondary battery may be improved within a range in which where the safety thereof is not problematic.

In some embodiments, a loading weight (LW) ratio of the first cathode mixture layer 21 and the second cathode mixture layer 22 may be 30:70 to 70:30. Specifically, the loading weight (LW) ratio of the first cathode mixture layer 21 and the second cathode mixture layer 22 may be 40:60 to 60:40, or 45:55 to 55:45.

In some embodiments, a loading weight of the first cathode mixture layer 21 may be 6 mg/cm² to 14 mg/cm². For example, the loading weight of the first cathode mixture layer 21 may be 8 mg/cm² or greater and 12 mg/cm² or less.

In some embodiments, a loading weight of the second cathode mixture layer 22 may be 6 mg/cm² to 14 mg/cm². For example, the loading weight of the second cathode mixture layer 22 may be 8 mg/cm² or greater and 12 mg/cm² or less.

When the loading weight relationship and range of the first cathode mixture layer 21 and the second cathode mixture layer 22 are as described above, the capacity of the cathode 100 for a lithium secondary battery may be increased while also ensuring excellent cycle lifespan performance thereof.

In some embodiments, the lithium metal phosphate may be represented by the following Chemical Formula 1:

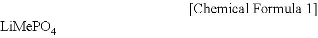

In Chemical Formula 1, Me is at least one element selected from the group consisting of Co, Ni, Fe and Mn.

The lithium metal phosphate represented by the chemical formula 1 may be lithium metal oxide particles having an olivine structure exhibiting excellent structural stability. For example, the lithium metal phosphate may include a lithium iron phosphate (LFP)-based active material including iron (Fe).

In some embodiments, the lithium metal phosphate may be a lithium manganese iron phosphate (LMFP)-based active material represented by the chemical formula, LiMnₓFe₁₋ₓPO₄ (0<x<1). Specifically, in the chemical formula, 0.5≤x≤0.7 may be satisfied. In this case, the performance of a cathode including the lithium manganese iron phosphate (LMFP)-based active material, such as energy density, may be improved.

The LMFP-based active material is an active material in which some of the iron (Fe) in the LFP-based active material is replaced with manganese (Mn), and thus, the LMFP-based active material may exhibit relatively superior energy density and low-temperature performance as compared to the LFP-based active material. Accordingly, when the cathode 100 for a lithium secondary battery includes an LMFP-based active material, a lithium secondary battery having high-energy density may be provided.

A particle composition of the lithium metal phosphate may be confirmed by inductively coupled plasma (ICP) analysis. For example, the lithium metal phosphate particles may be analyzed by ICP and the number of phosphorus atoms may be normalized to 1 to obtain a chemical formula.

In some embodiments, the lithium transition metal oxide may include a layered structure or crystal structure represented by the following chemical formula 2.

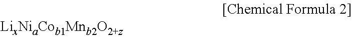

In the chemical formula 2, 0.9≤x≤1.2, 0.6≤a≤0.99, 0.01≤b1+b2≤0.4, and −0.5≤z≤0.1 may be satisfied.

The chemical structure represented by the chemical formula 2 represents bonding relationships within the layered or crystal structure of the cathode active material, and Ni, Co, and Mn may serve as main active elements of the cathode active material. That is, the chemical structure represented by chemical formula 2 is provided to represent the bonding relationships of the main active elements, and does not exclude other additional elements. Accordingly, chemical formula 2 should be understood to encompass the introduction and substitution of additional elements.

In some embodiments, auxiliary elements may be further included in addition to the main active element to enhance the chemical stability of the cathode active material or the layered/crystal structure. The auxiliary elements may be incorporated into the layered/crystal structure to form bonds, which should also be understood to fall within the chemical structure represented by chemical formula 2.

The auxiliary elements may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr. The auxiliary element, for example, Al, may act as an auxiliary active element that contributes to the capacity/power activity of the cathode active material, together with Co or Mn.

In some embodiments, the cathode active material may further include a coating material or a doping material including a coating element or a doping element. For example, elements substantially identical to or similar to the above-described auxiliary elements may be used as the coating element or doping element. For example, the above-described auxiliary elements may be used singly or in combination as coating elements or doping elements. In this case, an upper operating voltage limit of the lithium secondary battery may be controlled, thereby suppressing voltage decay of the lithium secondary battery.

The coating element or the doping element may be present on a particle surface of the cathode active material, or may penetrate through the particle surface of the cathode active material and may be incorporated into a bonding structure represented by chemical formula 2.

In some embodiments, the coating element may form a sea-type coating layer or an island-type coating layer.

In some embodiments, the content of the coating element in the particles of the cathode active material may range from 500 to 8,000 ppm, from 1,000 to 8,000 ppm, or from 1,500 to 8,000 ppm, based on the total weight of all elements excluding lithium and oxygen. When the content of the coating element is as described above, an initial capacity decrease and resistance increase of a lithium secondary battery may be prevented, and the voltage decay of the lithium secondary battery may be further suppressed.

In some embodiments, the coating material may be formed using a dry coating method or a wet coating method. For example, the cathode active material particles and the coating source may be dry-mixed or wet-mixed and heat-treated (e.g., sintered or dried) to form the coating material on a surface of the cathode active material particles. Any coating source known in the pertinent technical field may be used as the coating source. For example, the coating source may include B, Al, W, Zr, Ti, Mg, Co, or the like.

In some embodiments, the content of nickel (for example, a mole fraction of nickel among the total moles of nickel, cobalt, and manganese) in the lithium transition metal oxide may be greater than or equal to 0.6 and less than or equal to 0.7. Specifically, the content of nickel (for example, the mole fraction of nickel among the total moles of nickel, cobalt, and manganese) in the lithium transition metal oxide may be greater than or equal to 0.6 and less than or equal to 0.65. In this case, thermal stability thereof may be superior to that of lithium transition metal oxides having a Ni content of 0.7 or more.

The particle composition of the lithium transition metal oxide may be confirmed by inductively coupled plasma (ICP) analysis. For example, particles of the cathode active material may be analyzed by the ICP, and the number of oxygen atoms may be normalized to 1.8 to 2.2 (for example, 2), thus yielding the chemical formula of the cathode active material.

In some embodiments, the lithium transition metal oxide may have a single particle form. Specifically, the lithium transition metal oxide may be a single particle formed of a single crystal.

The term “single particle form” used herein is used to exclude secondary particles formed by, for example, the aggregation of a plurality of primary particles. For example, secondary particle structures in which primary particles (e.g., more than 10, 20, 30, 40, 50, and the like) are assembled or agglomerated in the lithium transition metal oxide may be excluded.

Furthermore, the term “single particle form” used herein does not exclude having, for example, a single particle formed by simply adhering or contacting two to ten single particles without aggregation.

When the cathode 100 for a lithium secondary battery includes a lithium transition metal oxide having a single particle form, the energy density and lifespan performance of the secondary battery may be further improved.

Whether the lithium transition metal oxide has a single particle form may be determined based on an ion image obtained by analyzing a cross-section of the active material particle using a Focused Ion Beam (FIB). For example, when the active material particle has a polycrystalline structure, even if the active material particle is observed as a single particle in an SEM cross-sectional image, in the FIB analysis image, two or more single crystals may be observed as particles comprised of two or more crystals, depending on differences in crystal orientation. Accordingly, when two or more single crystals due to differences in crystal orientation are not observed in the FIB analysis image, the active material particle may be determined to have a single particle form.

In some embodiments, each of the first cathode mixture layer 21 and the second cathode mixture layer 22 may further include a binder. The binder is not particularly limited. For example, the binder may include one or more of: polyvinylidene fluoride, styrene butadiene rubber (SBR), polytetrafluoroethylene, vinylidene fluoride/hexafluoropropylene copolymer, polyacrylonitrile, and polymethyl methacrylate. The binder content in the first cathode mixture layer 21 and the second cathode mixture layer 22 is not particularly limited, and may, for example, range from 0.1 wt % to 10 wt %, respectively.

In some embodiments, the first cathode mixture layer 21 and the second cathode mixture layer 22 may further include a conductive material. The conductive material may include one or more of: graphite, such as natural graphite or artificial graphite; carbon-based materials, such as carbon black, acetylene black, Ketjen black, channel black, furnace black, lamp black, thermal black, carbon fiber, or carbon nanotubes (CNT); metal powder particles or metal fibers, such as copper, nickel, aluminum, or silver; conductive whiskers, such as zinc oxide or potassium titanate; conductive metal oxides, such as titanium oxide; or conductive polymers, such as polyphenylene derivatives. The content of the conductive material in the first cathode mixture layer 21 and the second cathode mixture layer 22 is not particularly limited, and may range from 0.1 wt % to 10 wt %, respectively.

In some embodiments, each of the first cathode mixture layer 21 and the second cathode mixture layer 22 may include carbon nanotubes (CNT) and carbon black as conductive materials. In this case, the performance of the cathode 100 for a lithium secondary battery may be improved.

In some embodiments, a weight ratio of the carbon nanotubes (CNT) and carbon black in the first cathode mixture layer 21 may be 1:1 to 2:1, or 1.5 to 1.8. Furthermore, the weight ratio of the carbon nanotubes (CNT) and carbon black in the second cathode mixture layer 22 may be 1:1 to 2:1, or 1.5 to 1.8. The carbon black is a particle-type conductive material that may enhance conductivity between active material particles, and excessive inclusion of the carbon black may enhance conductivity, but may also reduce the active material content, resulting in a decrease in capacity. On the other hand, linear conductive materials such as carbon nanotubes (CNT) are expensive, making it difficult to increase a content thereof. Accordingly, the weight ratio of the carbon nanotubes (CNT) and carbon black may be adjusted within the above-described range, the respective advantages of the CNT and the carbon black may be maximized and disadvantages thereof minimized.

The cathode 100 for a lithium secondary battery according to the above-described embodiments may be manufactured using the following method.

### Method for Manufacturing a Lithium Secondary Battery

A method for manufacturing a cathode 100 for a lithium secondary battery) according to an embodiment includes: manufacturing a first cathode slurry including a first cathode active material and a second cathode slurry including a second cathode active material; and forming a cathode mixture layer 20 on at least one surface of the cathode current collector 10, and the cathode mixture layer 20 includes: a first cathode mixture layer 21 on the cathode current collector 10; and a second cathode mixture layer 22 on the first cathode mixture layer 21.

Detailed descriptions of the cathode current collector 10, the cathode mixture layer 20, the first cathode mixture layer 21, and the second cathode mixture layer 22 overlap the above-described content, and thus, redundant descriptions thereof will be omitted.

In some embodiments, the first cathode slurry and the second cathode slurry may be manufactured by mixing the first cathode active material and the second cathode active material with a solvent, respectively. The solvent is not particularly limited. For example, the solvent may be N-methyl-2-pyrrolidone (NMP).

In some embodiments, the first cathode slurry and the second cathode slurry may further include components such as a binder and a conductive agent. Detailed descriptions of the binder and the conductive agent overlap the above-described content and thus, redundant descriptions thereof will be omitted.

In some embodiments, the first cathode mixture layer 21 may be formed by applying the first cathode slurry to at least one surface of the cathode current collector 10 and then drying the first cathode slurry. The second cathode mixture layer 22 may be formed by applying the second cathode slurry to the first cathode slurry or the first cathode mixture layer 21 and then drying the second cathode slurry. According to an embodiment, the second cathode mixture layer 22 may be manufactured by applying the second cathode slurry to the previously formed first cathode mixture layer 21 and then drying the second cathode slurry. According to another embodiment, the first cathode slurry and the second cathode slurry may be simultaneously applied to a surface of the cathode current collector 10 and then dried simultaneously, thereby forming the first cathode mixture layer 21 and the second cathode mixture layer 22 simultaneously.

A method for applying the first anode slurry and the second anode slurry is not particularly limited. For example, the first anode slurry and the second anode slurry may be applied using a method such as bar coating, casting, or spraying.

In some embodiments, the drying of the first cathode slurry and the second cathode slurry may be performed at a temperature of 100 to 200° C. For example, the drying of the first cathode slurry and the second cathode slurry may be performed at a temperature of 130 to 170° C.

### Lithium Secondary Battery

According to an embodiment, a lithium secondary battery includes a cathode for a lithium secondary battery according to any one of the embodiments described above. For example, the lithium secondary battery may include a unit cell including the cathode for a lithium secondary battery described above, an anode, and a separator. The separator may be disposed between the cathode and the anode within the unit cell.

The anode is not particularly limited. For example, the anode may include an anode current collector; and an anode mixture layer on at least one surface of the anode current collector.

The components of the anode current collector are not particularly limited. For example, the anode current collector may be a plate or a foil formed of one or more of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and alloys thereof. In some embodiments, the anode current collector may be a copper foil (Cu-foil).

A thickness of the anode current collector is not particularly limited. For example, the thickness of the anode current collector may be 0.1 to 50 μm. In some embodiments, the thickness of the anode current collector may be 1 μm or more or 5 μm or more, and 20 μm or less or 10 μm or less.

The anode mixture layer may include an anode active material. The anode active material is not particularly limited. For example, the anode active material may be at least one selected from the group consisting of carbon-based materials such as crystalline carbon, amorphous carbon, carbon composites, and carbon fibers; lithium metal; lithium alloys; a silicon-including material and a tin-including material.

The crystalline carbon may, for example, be graphitic carbon such as natural graphite, artificial graphite, graphitized coke, mesocarbon microbeads (MCMB), or graphitized mesophase pitch-based carbon fiber (MPCF).

The amorphous carbon may, for example, be hard carbon, soft carbon, coke, mesocarbon microbeads (MCMB), or mesophase pitch-based carbon fiber (MPCF).

The elements included in the lithium alloy may, for example, be aluminum, zinc, bismuth, cadmium, antimony, silicon, lead, tin, gallium, or indium.

The silicon-containing material is not particularly limited as long as this includes silicon, and may be an active material capable of alloying with lithium (Li). For example, the silicon-containing material may be one or more selected from the group consisting of silicon (Si), silicon oxide (SiOₓ; 0<x<2), metal-doped silicon oxide (SiOₓ; 0<x<2), carbon-coated silicon oxide (SiOₓ; 0<x<2), silicon-carbon composite (Si—C), and silicon alloys.

The anode mixture layer may further include a binder. The binder is not particularly limited. For example, the binder may be one of a rubber-based binder such as styrene-butadiene rubber (SBR), fluororubber, ethylene propylene rubber, butadiene rubber, isoprene rubber, or silane rubber; a cellulose-based binder such as carboxymethylcellulose (CMC), hydroxypropylmethylcellulose, methylcellulose, or an alkali metal salt thereof; and combinations thereof.

The anode mixture layer may further include a conductive material. The conductive material is not particularly limited. For example, the conductive material may be one or more selected from a particulate carbon material and a fibrous carbon material. The particulate carbon material may be carbon black such as Super-P or Super-C, acetylene black, Ketjen black, or the like, and the fibrous carbon material may be carbon fiber, carbon nanotubes (CNT), vapor-grown carbon fiber (VGCF), or the like.

The separator is not particularly limited. For example, the separator may include a porous polymer film formed of a polyolefin polymer, such as an ethylene homopolymer, a propylene homopolymer, an ethylene/butene copolymer, an ethylene/hexene copolymer, or an ethylene/methacrylate copolymer. Furthermore, the separator may include a nonwoven fabric formed of high-melting-point glass fibers, polyethylene terephthalate fibers, or the like.

In some embodiments, the lithium secondary battery may be manufactured by housing the above-described unit cell in a pouch, which is a battery case, and then injecting an electrolyte thereinto.

The electrolyte may include an organic solvent and a lithium salt. The organic solvent serves as a medium through which ions involved in the electrochemical reaction of the battery may move, and may be used, for example, as carbonate-based, ester-based, ether-based, ketone-based, alcohol-based, or aprotic solvents, either alone or as a combination of two or more thereof, and when two or more solvents are used in combination, a mixing ratio thereof may be appropriately adjusted depending on desired battery performance.

The lithium salt is dissolved in the organic solvent and acts as a source of lithium ions within the battery, and is a material enabling a basic operation of a lithium secondary battery, and promoting the movement of lithium ions between the cathode and the anode. Any known material may be used as the lithium salt at a concentration appropriate for the intended purpose. The electrolyte may further include known solvents and known additives, as needed, to improve charge/discharge characteristics, flame retardancy, and other properties, and may include known additives.

In some embodiments, the unit cell may not include a separator between the cathode and the anode and may include a solid electrolyte. The solid electrolyte is not particularly limited and may be, for example, an oxide-based solid electrolyte, a sulfide-based solid electrolyte, or a polymer-based solid electrolyte.

### Inventive Example

### 1. Manufacturing of Cathode and Secondary Battery

### 1) Manufacturing of Cathode for Lithium Secondary Battery

### (1) Inventive Example 1

An LMFP-based active material represented by a chemical formula, LiMn_{0.6}Fe_{0.4}PO₄, was prepared as a lithium metal phosphate, an NCM-based active material in the form of a single particle represented by a chemical formula, LiNi_{0.6}Co_{0.1}Mn_{0.3}O₂, was prepared as a lithium transition metal oxide, carbon nanotubes (CNT) and carbon black were prepared as conductive materials (CNT: carbon black weight ratio=0.72:0.42), and polyvinylidene fluoride (PVDF) was prepared as a binder.

Based on the solids content, a first cathode slurry was produced by mixing 87.71 wt % of lithium metal phosphate, 9.75 wt % of lithium transition metal oxide, 1.4 wt % of a binder and 1.14 wt % of a conductive material with a solvent (N-methyl-2-pyrrolidone; NMP). A weight ratio of lithium metal phosphate and lithium transition metal oxide in the finally produced first cathode slurry was approximately 9:1.

Furthermore, based on the solids content, a second cathode slurry was produced by mixing 48.88 wt % of lithium metal phosphate, 48.88 wt % of lithium transition metal oxide, 1.1 wt % of a binder, and 1.14 wt % of a conductive agent with a solvent (NMP). A weight ratio of lithium metal phosphate and lithium transition metal oxide in the finally produced second cathode slurry was 5:5.

The first cathode slurry was applied to one surface of a cathode current collector (Al-foil) having a thickness of 12 μm at a loading weight of 10 mg/cm², and concurrently, the second cathode slurry was applied to a surface of the first cathode slurry at a loading weight of 10 mg/cm². In this case, the first cathode slurry and the second cathode slurry were applied so that a loading weight ratio of the first cathode mixture layer (lower layer) and the second cathode mixture layer (upper layer) was 5:5.

Then, the first cathode mixture layer and the second cathode mixture layer were dried to form the first cathode mixture layer and the second cathode mixture layer on one surface of the cathode current collector, which were then rolled at a thickness of 150 μm and a density of 2.899 g/cc, thereby manufacturing a cathode of Inventive Example 1. In the finally manufactured cathode, a weight ratio of lithium metal phosphate and lithium transition metal oxide based on the entire electrode was about 7:3.

### (2) Comparative Example 1

Based on the solids content, a third cathode slurry was produced by mixing 68.33 wt % of lithium metal phosphate, 29.28 wt % of lithium transition metal oxide, 1.25 wt % of binder, and 1.14 wt % of a conductive agent with a solvent (NMP). A weight ratio of lithium metal phosphate and lithium transition metal oxide in the finally produced third cathode slurry was about 7:3.

Then, the third cathode slurry alone was applied to one surface of a cathode current collector (Al-foil) at a loading weight of 20 mg/cm², thus manufacturing a cathode of Comparative Example 1 in the same manner as that of Inventive Example 1, except that a cathode mixture layer is formed of a single layer.

### (3) Comparative Example 2

Based on the solids content, a first cathode slurry including only lithium metal phosphate as the cathode active material was produced by mixing 97.46 wt % of lithium metal phosphate, 1.4 wt % of a binder, and 1.14 wt % of a conductive agent with a solvent (NMP).

Furthermore, based on the solids content, a second cathode slurry including only lithium transition metal oxide as the cathode active material was produced by mixing 97.96 wt % of lithium transition metal oxide, 0.9 wt % of a binder, and 1.14 wt % of a conductive agent with a solvent (NMP).

Then, a cathode of Comparative Example 2 was manufactured in the same manner as that of Inventive Example 1, except that the first cathode slurry and the second cathode slurry were applied so that a loading weight ratio of the first cathode mixture layer (lower layer) and the second cathode mixture layer (upper layer) was 7:3.

### (4) Comparative Example 3

Based on the solids content, a first cathode slurry was produced by mixing 48.88 wt % of lithium metal phosphate, 48.88 wt % of lithium transition metal oxide, 1.1 wt % of a binder, and 1.14 wt % of a conductive agent with a solvent (NMP).

Furthermore, based on solids content, a second cathode slurry was produced by mixing 87.71 wt % of lithium metal phosphate, 9.75 wt % of lithium transition metal oxide, 1.4 wt % of a binder, and 1.14 wt % of a conductive agent with a solvent (NMP).

Then, a cathode of Comparative Example 3 was manufactured in the same manner as that of Inventive Example 1, except that the first cathode slurry and the second cathode slurry were applied so that a loading weight ratio of the first cathode mixture layer (lower layer) and the second cathode mixture layer (upper layer) was 5:5.

### 2) Manufacturing of Secondary Battery

A cathode slurry (including artificial graphite, natural graphite, CMC and SBR in a weight ratio of 68.3:29.3:1.2:1.2 based on the solids content) was applied to a copper foil (Cu-foil) having the thickness of 6 μm and then dried to manufacture an anode for a lithium secondary battery. A secondary battery cell manufactured by interposing a polyolefin separator between the cathode and the anode as described above was inserted in a secondary battery pouch, and then, an electrolyte solution including 1.2 M of LiPF₆ dissolved in a solvent obtained by mixing ethylene carbonate (EC) and ethyl methyl carbonate (EMC) was injected into the secondary battery pouch and then sealed, thereby manufacturing a pouch-type lithium secondary battery. The manufactured pouch-type lithium secondary battery was applied as a secondary battery sample in Inventive Examples and Comparative Examples.

TABLE 1

| | | Type and weight ratio | | | |
|---|---|---|---|---|---|
| | | of upper and lower | | | Active |
| | | layer active materials | | | material |
| | | Lower | Upper | | weight |
| | | Layer | Layer | | ratio |
| | Elec- | (First | (Second | Lower:Upper | based |
| | trode | cathode | cathode | Loading | on the |
| | Struc- | mixture | mixture | Weight | entire |
| | ture | layer) | layer) | (LW) Ratio | electrode |
| Inventive | Dual | LMFP + | LMFP + | 5:5 | LMFP + |
| Example 1 | Layer | NCM | NCM | | NCM |
| | | (9:1) | (5:5) | | (7:3) |
| Comparative | Single | LMFP + NCM | | — | LMFP + |
| Example 1 | Layer | (7:3) | | | NCM |
| | | | | | (7:3) |
| Comparative | Dual | LMFP | NCM | 7:3 | LMFP + |
| Example 2 | Layer | | | | NCM |
| | | | | | (7:3) |
| Comparative | Dual | LMFP + | LMFP + | 5:5 | LMFP + |
| Example3 | Layer | NCM | NCM | | NCM |
| | | (5:5) | (9:1) | | (7:3) |

### 2. Evaluation of Cathode and Secondary Battery

### 1) Comparison of Cathode Electrode Density

The anode electrode densities (g/cc) that may be implemented when the cathode electrodes of Inventive Example 1 and Comparative Examples 1 to 3 are maximally pressed are shown in Table 2.

TABLE 2

| | Design electrode | Actual electrode mixture |
|---|---|---|
| | mixture density (g/cc) | density after pressing (g/cc) |
| Inventive | 2.899 | 2.850 |
| Example 1 | | |
| Comparative | 2.899 | 2.859 |
| Example 1 | | |
| Comparative | 2.899 | 2.772 |
| Example 2 | | |
| Comparative | 2.899 | 2.857 |
| Example 3 | | |

Referring to Tables 1 and 2 above, when LMFP and NCM are partially mixed as active materials in each cathode mixture layer and a total active material weight ratio is LMFP:NCM=7:3, it may be confirmed that an actual electrode mixture density of about 2.85 to 2.86 g/cc is achieved.

However, comparing Inventive Example 1 and Comparative Example 2, while the total active material weight ratio is the same (LMFP:NCM=7:3), the first cathode mixture layer of Comparative Example 2 is comprised solely of nano-sized LMFP, from which it is confirming that the actual electrode mixture density is inferior to that of Inventive Example 1.

### 2) Evaluation of Bipolar Coin Cell Capacity and Efficiency

Cathode half-coin cells of Inventive Example 1 and Comparative Examples 1 to 3 were subjected to two charge/discharge cycles: CC/CV charging at 0.1 C, 4.4 V, and a 0.05 C cutoff at 25° C., followed by 10-minute standing, and CC discharging at 0.1 C, 3.0 V cutoff, followed by 10-minute standing, and the charge and discharge capacities and capacity efficiencies of the first cycle are shown in Table 3.

TABLE 3

| | | | Cathode coin cell |
|---|---|---|---|
| | Cathode coin cell | Cathode coin cell | discharge/charge |
| | charging | discharge | capacity |
| | capacity (mAh/g) | capacity (mAh/g) | efficiency (%) |
| Inventive | 175 | 161.9 | 92.5 |
| Example 1 | | | |
| Comparative | 174 | 160 | 92.0 |
| Example 1 | | | |
| Comparative | 176 | 165 | 93.8 |
| Example 2 | | | |
| Comparative | 175 | 161 | 92.0 |
| Example 3 | | | |

Referring to Tables 1 and 3 above, it may be confirmed that Inventive Example 1 and Comparative Examples 2 and 3 in which an electrode structure has a dual layer, have superior capacity and efficiency as compared to Comparative Example 1 in which an electrode structure has a single layer.

Furthermore, comparing Inventive Example 1 and Comparative Examples 2 and 3, it may be seen that capacity and efficiency increase as the LMFP ratio in the first cathode mixture layer increases and the NCM ratio in the second cathode mixture layer increases. However, as confirmed in Table 2, in the cathode of Comparative Example 2 in which the first cathode mixture layer is comprised solely of nano-sized LMFP, an actual realized electrode mixture density may be lower than that of Inventive Example 1.

Accordingly, as in Inventive Example 1, when the first cathode mixture layer and the second cathode mixture layer include LMFP and NCM active materials, respectively, and the first cathode mixture layer has a relatively high LMFP content and the second cathode mixture layer has a relatively high NCM content, performance, including electrode processability, electrode mixture density, battery capacity, and safety, may be improved.

What is claimed is:

1. A cathode for a lithium secondary battery, comprising: a cathode current collector; and a cathode mixture layer on at least one surface of the cathode current collector,
wherein the cathode mixture layer includes: a first cathode mixture layer on the cathode current collector; and a second cathode mixture layer on the first cathode mixture layer,
each of the first cathode mixture layer and the second cathode mixture layer independently includes a lithium metal phosphate as an active material,
at least one of the first cathode mixture layer and the second cathode mixture layer includes a lithium transition metal oxide as an active material, and
a weight of the lithium metal phosphate included in the first cathode mixture layer is greater than or equal to a weight of the lithium metal phosphate included in the second cathode mixture layer.

2. The cathode for a lithium secondary battery of claim 1, wherein, when the first cathode mixture layer includes a lithium transition metal oxide, a weight of the lithium metal phosphate included in the first cathode mixture layer is greater than or equal to a weight of the lithium transition metal oxide included in the first cathode mixture layer.

3. The cathode for a lithium secondary battery of claim 2, wherein a weight ratio of the lithium metal phosphate and the lithium transition metal oxide included in the first cathode mixture layer is 70:30 to 99:1.

4. The cathode for a lithium secondary battery of claim 1, wherein, when the second cathode mixture layer includes a lithium transition metal oxide, a weight ratio of the lithium metal phosphate and the lithium transition metal oxide included in the second cathode mixture layer is 30:70 to 70:30.

5. The cathode for a lithium secondary battery of claim 1, wherein a total weight of the lithium metal phosphate included in the cathode mixture layer is greater than or equal to a total weight of the lithium transition metal oxide included in the cathode mixture layer.

6. The cathode for a lithium secondary battery of claim 5, wherein a weight ratio of the lithium metal phosphate and the lithium transition metal oxide included in the cathode mixture layer is 60:40 to 80:20.

7. The cathode for a lithium secondary battery of claim 1, wherein a loading weight (LW) ratio of the first cathode mixture layer and the second cathode mixture layer is 30:70 to 70:30.

8. The cathode for a lithium secondary battery of claim 1, wherein the lithium metal phosphate is a lithium manganese iron phosphate (LMFP)-based active material represented by a chemical formula, LiMnₓFe₁₋ₓPO₄(0<x<1).

9. The cathode for a lithium secondary battery of claim 1, wherein the lithium transition metal oxide has a single particle form.

10. A lithium secondary battery comprising the cathode for a lithium secondary battery according to claim 1.
